(19) United States
(12) Patent Application Publication
(10) Pub. No.: US 2006/0135091 A1
(43) Pub. Date: Jun. 22, 2006

(54) Priority information management device for a radio communication terminal of a radio communication network

(75) Inventors: Joel Ntsonde, Paris (FR); Paul Vincent, Plaisance Du Touch (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/305,009

(22) Filed: Dec. 19, 2005

(30) Foreign Application Priority Data
Dec. 20, 2004 (EP) 04293069.3

(51) Int. Cl. H04B 1/034

(52) U.S. Cl. 455/95; 455/12.1

(57) ABSTRACT

A device is dedicated to managing priority information in a radio communication terminal of a radio communication network, comprising a communication module able to communicate with the network. The device includes processing means adapted, in the event of reception by the hybrid communication module of a message broadcast by the network in a “primary” area and containing at least one designation of at least one “secondary” area included in the primary area, to determine if the terminal is in the designated secondary area in order to authorize the terminal to set up a priority call with the network and/or to display any priority information contained in the received message if the terminal is in the secondary area.

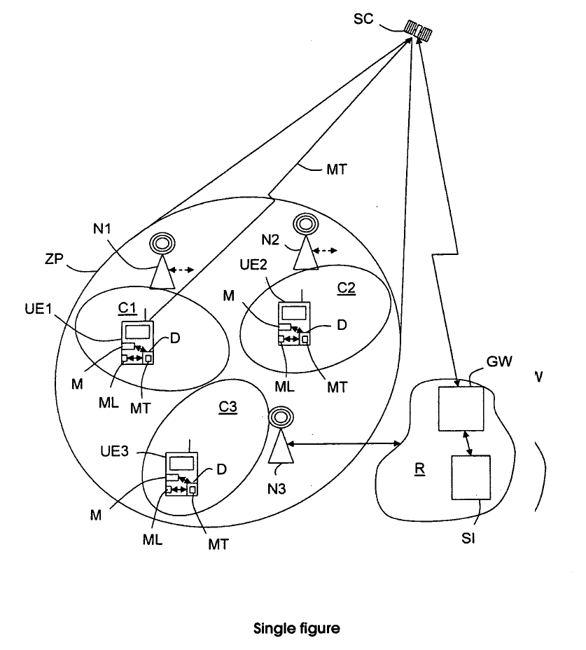

### CROSS-REFERENCE TO RELATED APPLICATIONS

This application is based on French Patent Application No. 04 293 069.3 filed Dec. 20, 2004, the disclosure of which is hereby incorporated by reference thereto in its entirety, and the priority of which is hereby claimed under 35 U.S.C. §119.

### BACKGROUND OF THE INVENTION

1. Field of the Invention

The invention concerns radio communication networks and to be more precise the management of calls in selected parts of such networks.

In the present context, the expression “radio communication network” refers to a mobile (or cellular) network, for example of GSM, GPRS/EDGE, UMTS or CDMA 2000 type, including a terrestrial radio access network, defining a plurality of cells, and to a hybrid or purely satellite communication network.

In the present context, the expression “hybrid communication network” refers to a satellite (tele)communication network including a multiplicity of terrestrial repeaters or a mobile or cellular network including a terrestrial radio access network, defining a plurality of cells, and a satellite access network, comprising at least one communication satellite covering at least one “primary” terrestrial area including a plurality of cells, and preferably a large number of cells.

Furthermore, in the present context, the expression “satellite network” refers to a (tele)communication network including a satellite access network comprising at least one communication satellite covering at least one primary terrestrial area.

2. Description of the Prior Art

The telephone is a particularly widespread communication tool that is particularly well adapted to live transmission of information. This is even more particularly the case in mobile (or cellular) telephone networks because they make it possible to contact a person equipped with a mobile communication terminal, including when that person is not at home.

However, communication by telephone is possible only if the radio access network of the telephone network is serviceable. Now, in certain situations, such as a major natural disaster, for example, telephone infrastructures providing telephone connections may be damaged, or even destroyed, so that it becomes difficult, or even impossible, to contact persons to send them priority information either in the form of alarm messages or verbally.

A satellite network or a hybrid network overcomes this problem as it makes it possible to contact many hybrid communication terminals via its communication satellite(s), regardless of the situation on the ground. However, a satellite digital multimedia broadcast (SDMB) communication satellite can broadcast messages only throughout its primary coverage area, which may be very extensive, for example a region or a complete country. Consequently, it is not possible to restrict the broadcasting of messages to a selected portion of a primary coverage area.

Now, that might prove particularly useful, in particular in the event of a (local) natural disaster or to provide (local) warning of an imminent disaster, since this would make it possible to warn only the group of persons who are really concerned and therefore prevent widespread panic and/or saturation of telephone connections.

It is true that in certain cellular networks it is possible to configure the terrestrial radio access network temporarily in such a way as to prohibit calls in at least one cell, for example to carry out maintenance operations (as described in particular in 3GPP Technical Specifications TS 22.011 and TS 25.331). However, this is to the detriment of customers in the cells in which calls are prohibited. Moreover, it is not possible in this case to reassign radio resources assigned to the prohibited cells to cells that temporarily need them.

No prior art solution proving entirely satisfactory, an object of the invention is therefore to improve on the situation.

### SUMMARY OF THE INVENTION

To this end the present invention proposes a device for managing priority information for a radio communication terminal of a radio communication network, comprising in particular a communication module.

The management device includes processing means adapted, in the event of reception by the communication module of their terminal of a message broadcast by the network in a “primary” area and containing at least the designation of at least one “secondary” area included in the primary area, to determine if the terminal is in the designated secondary area, so as to authorize the terminal to set up a priority call with the network and/or to display any priority information contained in the received message if the terminal is in the secondary area or one of the secondary areas.

The device of the invention may have other features and in particular, separately or in combination:
at least some of the broadcast messages may be alarm messages containing at least one designation of a secondary area and the priority information to be displayed;
at least some of the broadcast messages may include at least one designation of a secondary area and an alarm message containing the priority information to be displayed;
if the network is a hybrid or satellite type network (and therefore comprises at least one communication satellite covering the primary area including each designated secondary area), at least some of the messages broadcast by the satellite may be SIB (system information block) type system information messages containing at least one designation of a secondary area;
the SIB messages are, for example, dedicated messages and include a field for the designation of at least one secondary area;
its processing means may be adapted, if they have determined that the terminal is in a designated secondary area, to authorize the hybrid communication module to set up an emergency call to the network using dedicated resources (where applicable satellite resources in the case of a hybrid or satellite network);
its processing means may be adapted, if they have determined that the terminal is not in a designated secondary area, to prohibit the hybrid communication module from setting up an emergency call to the network using dedicated resources (where applicable satellite resources in the case of a hybrid or satellite network);
each designation may represent geographical positions defining an envelope of the designated secondary area; in this case, the processing means are adapted to determine if the position of the terminal is in the envelope corresponding to the designated secondary area;
alternatively, each designation may represent the identifier of the designated secondary area (or the identifiers of the cell or cells that constitute it in the case of a hybrid or purely cellular network); in this case, the processing means are adapted to determine geographical positions that define the envelope associated with the identifier of the designated secondary area (or the identifiers of the cell or cells that constitute it) and then to determine if the position of their terminal is in that envelope;
its processing means may be adapted to determine if the terminal is in a designated secondary area on the basis of data representing its geographical position supplied by location means (installed in the terminal or in a location server of the network).

The invention also proposes a radio communication terminal comprising a communication module able to communicate with a radio communication network and a management device of the above type.

A terminal of the above type may further comprise location means adapted to deliver data representing its geographical position, for example a radio navigation module (where applicable of the Global Positioning System (GPS) type) or an intercellular triangulation module (where applicable of the time of arrival (TOA) type).

The invention is particularly well adapted, although not exclusively so, to satellite networks, hybrid communication networks of GSM, GPRS/EDGE, UMTS and CDMA 2000 type, and mobile (or cellular) networks of GSM, GPRS/EDGE, UMTS and CDMA 2000 type.

### BRIEF DESCRIPTION OF THE DRAWING

Other features and advantages of the invention will become apparent on reading the following detailed description and examining the appended drawing, the single FIGURE whereof shows very diagrammatically a hybrid communication network equipped with a priority information server for hybrid communication terminals equipped with a management device of the invention. The appended drawing constitutes part of the description of the invention as well as contributing to the definition of the invention, if necessary.

### DETAILED DESCRIPTION OF THE PREFERRED EMBODIMENT

An object of the invention is to enable broadcasting of priority information to radio communication terminals in portions of a radio communication network.

It is considered hereinafter by way of nonlimiting example that the radio communication network is a hybrid network comprising a UMTS type cellular network including a terrestrial radio access network defining a plurality of cells Ci and a satellite access network comprising a communication satellite SC covering at least one “primary” terrestrial area ZP including a plurality of cells Ci, preferably a large number of cells.

It is important to note that the invention is not limited to UMTS type hybrid cellular networks. It concerns all cellular (or mobile) hybrid networks and in particular those of GSM, GPRS/EDGE and CDMA 2000 type. The invention also concerns, firstly, hybrid networks consisting of a satellite (tele)communication network and a multiplicity of terrestrial repeaters, secondly, satellite (tele)communication networks with no terrestrial repeaters, and, thirdly, mobile (or cellular) networks and in particular those of GSM, GPRS/EDGE, UMTS and CDMA 2000 type.

In the example illustrated by the single FIGURE the (terrestrial cellular) radio access network comprises only three cells Ci (i=1 to 3—C1 to C3). However, the suffix i can take any value greater than one (1).

Very broadly speaking, but nevertheless in sufficient detail for the invention to be understood, a UMTS type hybrid network may be summarized as a core network connected to a (terrestrial) radio access network (UTRAN) and to a satellite access network.

The satellite access network includes at least one communication satellite SC connected by radio to a satellite gateway GW that is responsible in particular for managing satellite resources. The satellite is a satellite digital multimedia broadcast (SDMB) type satellite, for example, so as to enable broadcasting of multimedia digital data to the set of communication terminals UEk (here the suffix k is from 1 to 3 (UE1 to UE3) but may take any value greater than or equal to 2) in its coverage area ZP.

The radio access network (UTRAN) includes a set of base stations Nj, known as Node Bs, and radio network controllers (RNCs) or nodes, connected to each other, and a radio access network manager.

Each base station (Node B) Nj (here the value of the suffix j is from 1 to 3 (N1 to N3), but j may take any value greater than or equal to 2) is associated with at least one cell Ci covering a radio area in which mobile communication terminals UEk can set up (or continue) radio links.

It is considered hereinafter by way of nonlimiting example that the mobile communication terminals UEk are mobile telephones equipped with a hybrid communication module MC. The invention is not limited to that type of hybrid communication terminal, however. It concerns all communication equipments including a hybrid communication module MC capable of exchanging signals by radio, firstly, with the base stations Nj (or repeaters) which control calls within the cells Ci of the mobile network (or satellite network), and, secondly, with the communication satellite(s) SC, and in particular laptop computers and personal digital assistants (PDAs) equipped with hybrid communication means enabling satellite and radio telephone links to be set up.

The core network comprises a set of network equipments connected to the radio network controllers (RNCs) and to the gateway GW as well as to a core network manager.

In the present example, the core network, the satellite access network, apart from the gateway GW and the communication satellite SC, and the radio access network (UTRAN), apart from its base stations Nj (node Bs), are lumped together in the form of the potato-shape R.

The invention proposes to equip the communication terminals UEk (here hybrid mobile telephones) with a device D dedicated to managing priority information and to have the network broadcast in a primary area, encompassing at least one “secondary” area, specific messages containing priority information data, including at least the designation of at least one secondary area.

It is important to note that, in the case of a hybrid network, a secondary area may be identical to a given cell Ci, as shown here. This is not obligatory, however. It may encompass a plurality of cells, at least partially, or constitute only a portion of a large cell. Moreover, in the case of a purely satellite network comprising at least one communication satellite, a secondary area is an area (or geographical extent) constituting a subportion of the primary coverage area of the communication satellite. Moreover, in the case of a cellular (or mobile) network, a primary area contains at least one secondary area that may be identical to a given cell or may encompass a plurality of cells, at least partially, or merely constitute a portion of a large cell.

In the application of the invention to a hybrid network, the specific messages are broadcast by the (communication) satellite SC throughout its coverage area (or primary area) ZP, which includes at least one secondary area of the radio access network (UTRAN).

The priority information data contained in the specific messages broadcast is defined by the operator in an information server SI, for example. The information server SI is installed in the satellite access network and connected to the gateway GW, for example. The gateway GW is responsible for constructing the specific messages to be broadcast, integrating therein information data received from the information server SI, and transmitting the information by radio to the satellite SC in order for it to broadcast the information in its coverage area ZP.

The types of specific message that are broadcast in accordance with the invention are further discussed later.

The management device D comprises at least one processing module MT which, if the hybrid communication module MC of its telephone UEk receives a specific message coming from the satellite SC (and containing at least the designation of at least one secondary area Ci), determines if that telephone UEk is in the designated secondary area(s). Then, if the telephone UEk is in the designated secondary area or one of the secondary designated areas, the processing module MT authorizes it to set up a priority call to the network by means of its (here hybrid) communication module MC and/or to display on its screen priority information, where applicable contained in the received specific message.

The method used by the processing module MT to obtain the position of the telephone UEk in which it is installed depends in particular on the type of specific message received, here from the satellite SC.

Any type of broadcast message, and more generally any type of content (or stream) to be broadcast, especially multimedia content (audio and/or video), may be envisaged.

At least three types of broadcast specific messages may be envisaged.

A first type of specific messages concerns alert message broadcasts. These may be MBMS service information type messages, for example, as described in the Technical Specification TS 35.346 “Introduction of Multimedia Broadcast/Multicast Service (MBMS) in the Radio Access Network (RAN); Stage 2”, to which a location element is added.

The invention proposes to integrate into the alarm messages, in addition to their usual data and in order for them to constitute specific messages to be broadcast, at least one designation of a secondary area Ci and priority information data intended to be displayed on the screens of the telephones UEk in each designated secondary area Ci.

Any type of priority information may be envisaged, for example a report of a natural disaster, an indication of the imminence of a natural disaster, an emergency number to be called to obtain accurate information or advice and/or recommended measures to be taken given the existing or imminent situation.

Each designation of a secondary area Ci and the associated priority information data are communicated to the gateway GW by the information server SI, in order for it to construct an alarm message incorporating that data, after which it sends it to the satellite SC for it to be broadcast in its coverage area ZP.

A second type of specific message concerns a variant of the alert messages described above.

The invention proposes to construct a specific message to be broadcast by combining with a conventional alarm message at least one designation of a secondary area Ci and priority information data intended to be displayed on the screens of the telephones UEk in each designated secondary area Ci.

Once again, any type of priority information may be envisaged.

Each designation of a secondary area Ci and the associated priority information data are also communicated to the gateway GW by the information server SI, in order for it to combine them with a conventional alarm message to constitute a specific message, after which it sends the latter message to the satellite SC in order for it to be broadcast in its coverage area ZP.

In the case of the first and second types, if the hybrid communication module MC of a telephone UEk receives a specific message, it forwards it to the management device D in order for its processing module MT to analyze at least a portion of its content.

To be more precise, the processing module MT begins by analyzing the data that designates each secondary area Ci. Two situations may then be envisaged.

In a first situation, the data that designates a second area Ci represents that secondary area or one or more identifiers of cells Ci of the hybrid network. In this case, the processing module MT must determine geographical positions globally defining the (secondary) coverage area designated by the identifier(s) contained in the specific message, or better still the boundaries delimiting that secondary area. To this end, the processing module MT can, for example, interrogate storage means that are preferably installed in its telephone UEk or in its management device D. Any type of storage means may be envisaged, and in particular a conventional memory, a database or a directory. The geographical position data may be stored in a table in corresponding relationship to secondary area or cell identifiers.

In a second situation, the data that designates a secondary area Ci directly represents geographical positions that globally define its (secondary) coverage area, or better still its boundaries.

Once the processing module MT is in possession of the geographical position data of each secondary area designated in the specific message received, it determines the geographical position of the telephone UEk in which it is installed.

Once again, two situations may be envisaged.

In a first situation (illustrated in the single FIGURE), the telephone UEk is equipped with a location module ML delivering position data. In this case, the processing module MT interrogates the location module ML to obtain the position data for the telephone UEk in which it is installed.

Any type of location module ML may be envisaged, and in particular a GNSS (or RNSS) type radio navigation module, for example a Global Positioning System (GPS), GLONASS or GALILEO system, or an intercellular triangulation module of the time of arrival (TOA) type.

The TOA technique consists in having the base stations that surround a mobile terminal send simultaneously signals to be analyzed including a time marker representing their sending time and, on reception by the mobile terminal of signals to be analyzed coming from at least two base stations and including time markers representing the same transmission time, determining by triangulation the position of the mobile terminal from said sending time and the reception times of the signals to be analyzed.

In a second situation, the telephone UEk is not equipped with a location module ML. In this case, the processing module MT must request its telephone UEk to interrogate the hybrid network in order to obtain the data defining its position. To this end, the hybrid network must include a location server for determining the geographical positions of the telephones UEk.

Any type of location technique may be envisaged, and in particular the enhanced observed time difference (EOTD) technique.

By requesting remote interrogation of the location server, the processing module MT can recover data defining the geographical position of the telephone UEk in which it is installed.

Once the processing module MT is in possession of the geographical position data for each secondary area designated in the specific message received and geographical position data for the telephone UEk in which it is installed, it compares them with each other in order to determine if said telephone UEk is in a designated secondary area or not.

If the telephone UEk is in a designated secondary area, the processing module MT authorizes it to display on its screen the priority information contained in the specific message received, and where applicable to request the setting up of an emergency (or priority) call, as explained below.

If not, the processing module MT prohibits the display of the priority information contained in the specific message received and the setting up of an emergency (or priority) call.

A third type of specific message concerns what the person skilled in the art knows as system information block (SIB) messages.

The invention proposes defining a new type of SIB message to constitute specific messages to be broadcast. At present 18 types of SIB message are already known in the art. These SIB messages are described in particular in the 3GPP Technical Specification TS 25.331 “Radio resource control (RRC) protocol specification”.

This new type of SIB message (N° 19) is intended to incorporate at least one designation of a secondary area Ci. The following is an example of the format of this kind of SIB message.

| | | | | | System |
|---|---|---|---|---|---|
| | | UE | UE | Program- | infor- |
| | Type | State/mode | State/mode | ming | mation |
| | of | if block is | if block is | infor- | modifi- |
| SIB | area | valid | read | mation | cation |
| N° 19 | Cell | Idle Mode | Idle Mode | Speci- | Value |
| | | CELL_FACH | CELL_FACH | fied by | indicator |
| | | CELL_PCH | CELL_PCH | IE | |
| | | URA_PCH | URA_PCH | | |

| Information | | | Type and | Semantic |
|---|---|---|---|---|
| element | Condition | Multi | reference | description |
| Service | Necessarily | | Description of | Geographical |
| validity | present | | geographical | coordinates of |
| area | | | area | service validity area |

In the above table, the abbreviation IE stands for “Information Element”.

The description of the geographical area may employ one of the methods defined in the 3GPP Technical Specification TS 23.032, for example, or a new method corresponding to the requirements of the operator of the hybrid network and/or to the specific features of said hybrid network.

Moreover, in the present context, the expression “service validity area” refers to the whole of at least one secondary area (for example a cell Ci) in which a service may be provided. Here the service consists in the possibility of setting up priority calls.

Each designation of a secondary area Ci is communicated to the gateway GW by the information server SI in order for it to constitute an SIB message of the type explained above (type N° 19), which then defines a specific message. The gateway GW then sends the specific (SIB) message to the satellite SC in order for it to broadcast it in its coverage area ZP.

If the hybrid communication module MC of a telephone UEk receives a specific message of the third type, it transmits it to the management device D in order for its processing module MT to analyze at least a portion of its content.

To be more precise, the processing module MT begins by analyzing the data that designates each secondary area Ci. As in the case of the first and second types of specific message, the data that designates a secondary area Ci can either represent the identifier of the secondary area Ci in the hybrid network (or identifier(s) of the cell(s) that constitute(s) that secondary area), or directly represent geographical positions that globally define its (secondary) coverage area, or better still its boundaries.

Once the processing module MT is in possession of the geographical position data for each secondary area designated in the received specific message, it determines the geographical position of the telephone UEk in which it is installed. As in the case of the first and second types of specific message, the geographical position of the telephone UEk may be determined in said telephone UEk if it has a location module ML delivering position data (for example a GNSS (or RNSS) type radio navigation module) or a TOA type intercellular triangulation module, or in the hybrid network if it has a location server for determining the geographical positions of the telephones UEk (for example using the EOTD technique).

Once the processing module MT is in possession of the geographical position data for each secondary area designated in the received specific message and geographical position data for the telephone UEk in which it is installed (recovered from the location module ML or from the location server), it compares them with each other to determine if said telephone UEk is in a designated secondary area or not.

If the telephone UEk is in a designated secondary area, the processing module MT then authorizes it to request the setting up of an emergency (or priority) call.

If not, the processing module MT prohibits the setting up of an emergency (or priority) call.

In the present context, the expression “emergency (or priority) call” refers to a call using satellite resources on the return link from the telephone UEk to the gateway GW via the satellite SC. As the person skilled in the art is aware, satellite links make some resources available to the terminals of the customers of the hybrid network. According to the invention, if necessary (i.e. in the event of broadcasting specific messages), the satellite resources are strictly reserved for telephones UEk in each priority secondary area designated in one of the specific messages.

Accordingly, a user can set up an emergency call, for example to an emergency call center, to obtain additional information and/or to request help.

The specific messages being broadcast throughout the coverage area ZP of a satellite SC, it is possible at any time to modify the secondary areas considered as priority areas. It suffices to broadcast a new specific message containing one or more new secondary area designations.

It is important to note that messages of different types can coexist within a hybrid network, provided that the processing modules MT of the devices D installed in the telephones UEk are adapted to process priority information contained in these different types of specific messages.

It is also important to note that the communication terminals that are in a priority cell Ci, just like those that are in non-priority cells, retain the possibility of setting up conventional radio calls with the hybrid network via its radio access network.

The management device D of the invention, and in particular its processing module MT, can take the form of electronic circuits, software (or electronic data processing) modules or a combination of circuits and software.

The invention is not limited to the management device and hybrid communication terminal embodiments described above by way of example only, and encompasses all variants that the person skilled in the art might envisage that fall within the scope of the following claims.

There is described above an application of the invention to a hybrid network. The invention is not limited to that type of communication network, however, and concerns also satellite networks and cellular (or mobile) networks.

In the case of a satellite network, a primary area is a coverage area of a communication satellite in which the specific messages are broadcast by radio, and a secondary area is an area (or geographical extent) constituting a subportion of a primary area. In the case of a cellular network, a primary area is an area encompassing a plurality of radio cells in which the specific messages are broadcast by base stations and a secondary area is an area that may be identical to a given cell or may encompass a plurality of cells, at least partially, or constitute only a portion of a large cell.

1. A device for managing priority information for a radio communication terminal of a radio communication network, comprising a communication module adapted to communicate with said network, processing means adapted, in the event of reception by said communication module of a message broadcast by said network in a “primary” area and containing at least the designation of at least one “secondary” area included in said primary area, to determine if said terminal is in said designated secondary area so as to authorize said terminal to set up a priority call with said network and/or to display any priority information contained in said received message if said terminal is in said secondary area.

2. The device according to claim 1, wherein at least some of said broadcast messages are alarm messages containing at least one designation of a secondary area and said priority information to be displayed.

3. The device according to claim 1, wherein at least some of said broadcast messages include at least one designation of a secondary area and an alarm message containing said priority information to be displayed.

4. The device according to claim 1, wherein, in the presence of a hybrid or satellite type network comprising at least one communication satellite covering said primary area including each designated secondary area, at least some of said messages broadcast by said communication satellite are SIB type system information messages containing at least one designation of a secondary area.

5. The device according to claim 4, wherein said SIB type system information messages are dedicated messages and include a field for the designation of at least one secondary area.

6. The device according to claim 1, wherein said processing means are adapted, if they have determined that said terminal is in a designated secondary area, to authorize said communication module to set up an emergency call to said network using dedicated resources.

7. The device according to claim 1, wherein said processing means are adapted, if they have determined that said terminal is not in a designated secondary area, to prohibit said communication module from setting up an emergency call to said network using dedicated resources.

8. The device according to claim 1, wherein each designation represents geographical positions defining an envelope of the designated secondary area and said processing means are adapted to determine if the position of said terminal is in said envelope.

9. The device according to claim 1, wherein each designation represents the identifier of the designated secondary area and said processing means are adapted to determine geographical positions that define an envelope associated with a designated secondary area identifier and then to determine if the position of said terminal is in said envelope.

10. The device according to claim 1, wherein, in the presence of a hybrid or cellular network, each designation represents each identifier of a cell constituting the designated secondary area and said processing means are adapted to determine the geographical positions that define a coverage envelope associated with each designated cell identifier and then to determine if the position of said terminal is in said envelope.

11. The device according to claim 1, wherein said processing means are adapted to determine if said terminal is in a designated secondary area on the basis of data representing its geographical position supplied by location means.

12. A radio communication terminal for a radio communication network, comprising a communication module able to communicate with said network and a management device according to claim 1.

13. The terminal according to claim 12, further comprising location means able to deliver said data representing its geographical position.

14. The terminal according to claim 13, wherein said location means are selected from a group comprising at least a radio navigation module and an intercellular triangulation module.

15. Use of the management device and the radio communication terminal according to claim 1 in radio communication networks selected from a group comprising hybrid networks, satellite networks and cellular networks.
